(19) United States
(12) Patent Application Publication
(10) Pub. No.: US 2014/0013565 A1
(43) Pub. Date: Jan. 16, 2014

(54) CUSTOMIZED PROCESS FOR FACILITATING SUCCESSFUL TOTAL KNEE ARTHROPLASTY WITH OUTCOMES ANALYSIS

(71) Applicants: Eileen B. MacDonald, Annapolis, MD (US); James H. MacDonald, Annapolis, MD (US)

(72) Inventors: Eileen B. MacDonald, Annapolis, MD (US); James H. MacDonald, Annapolis, MD (US)

(21) Appl. No.: 13/545,074

(22) Filed: Jul. 10, 2012

(51) Int. Cl. G06F 19/00

(52) U.S. Cl. CPC G06F 19/32
USPC 29/407.05; 703/11

(57) ABSTRACT

A method for producing a custom resection jig for a current patient scheduled to receive total knee arthroplasty using outcomes analysis comprising the steps of maintaining a database on a computer system of (1) prior patient bone morphology, (2) along with anatomical and mechanical bone alignment data and (3) data defining a custom resection jig design with a generally transverse resection window operable to guide a surgeon's transverse bone cut for prior patients that have received total knee arthroplasty and a post-surgery medically recognized scoring register greater or equal to a predetermined highly successful score value for a total knee arthroplasty procedure using prior success data to guide production of a current patient custom jig resection windows.

### BACKGROUND OF THE DISCLOSURE

The present disclosure relates to a process for facilitating successful joint replacements such as, for example, total knee replacement surgery. More specifically, the disclosure involves using image analysis, stored within a database, of successful and highly successful joint replacement procedures, such as total knee arthroplasty (“TKA”), with current patient physiology and joint morphology to produce a custom fitting distal resection jig suitable to facilitate and enhance the likelihood of a successful current procedure.

Joint replacement is indicated for patients who have severe debilitating pain due to joint cartilage wear or arthritis which occurs at a joint surface. Osteoarthritis is the most common form of arthritis, and this occurs when the cartilage surface that lines the bones is damaged. Cartilage is a cushion between the bony elements of a joint and, when intact, allows the joint to move smoothly and without pain. The current standard of care for patients that have severely worn or arthritic joints that have failed more conservative management, such as pain medication, injections, and exercise, is joint replacement. Specifically, replacement of the knee and hip joints are common and usually significantly improve the patient's quality of life due to diminished pain and improved mobility. Joint replacement is performed in a hospital setting or surgery center by an orthopedic surgeon, and is the process of removing affected bony surfaces of a joint and replacing them with foreign materials, such as metal and polyethylene, to create a new articular surface which is not painful.

Pre-operative planning can be a significant determinant of joint replacement outcome. It can guide correction of angular deformities, and also determine the size of an implant for each individual patient. Each patient usually requires a different size implant to accommodate the size and shape of their individual bones; for example, in knee replacement, a surgeon may choose from approximately eight different size femoral components and approximately eight different size tibial components with multiple thicknesses of polyethylene to fit between those implants. In most cases, the patella is also resurfaced with polyethylene components of differing diameters and thicknesses. Because there are many implant choices to make, optimal selection can be problematic and significantly impact surgical outcomes. In addition, patient leg and knee mechanical and anatomical axis alignment and proper patellofemoral tracking are important considerations in a successful TKA procedure. As an example distal femoral alignment of approximately five degrees of valgus and proximal tibial alignment of approximately neutral, or zero degrees varus/valgus, are goals to consider for long term patient satisfaction with a TKA procedure.

Pre-operative planning commonly includes analysis of two dimensional radiographs (x-rays) and surgeons often decide on which implant size to use by intraoperative measurements of the articular surfaces being replaced, and crude estimates based upon 2-dimensional images. A basic concept in joint replacement surgery is to “take as much bone as you are going to replace.” Outcomes using this approach, however, can be suboptimal, and some problems were sometimes encountered such as malalignment of a limb and across a joint surface. Malalignment might lead to poor patient satisfaction, including persistent pain or premature wear of the articular surfaces due to improper loading. In addition, sizing of the implants was not always accurate and relied upon the surgeon's intraoperative judgment and experience. Poor outcomes might include persistent pain, accelerated wear of the bearing surface, and/or loosening of the component, possibly requiring joint revision surgery which is a significant problem and an undesirable result. This underscores a need for properly sized and placed joint implants so that patients will have less pain and better mobility without the need for revision surgery.

Recently, medical device and implant manufacturing companies have been using 3-dimensional images of arthritic joints taken preoperatively to create 3-dimensional computer simulations of the joint. Engineers at the medical implant company will then analyze these 3-dimensional images and plan for the appropriate bony resection to create a best fit for their implants. The pre-operative image based plan is transferred to the operating room by using custom cutting jigs which can be intimately and accurately attached to a specific patient's articular surface. A jig is a guide affixed to the end of a bone during surgery, and a medical saw is guided through the jig to make an appropriate bony cut. At the time of surgery, the surgeon can execute the engineer's plan by applying the custom cutting jigs for that patient onto the articular surfaces, and making the appropriate bony resections, thereby following a pre-operative plan that had been produced by the engineer.

Even with this system of custom cutting jigs, bony resections may be inaccurate or even inappropriate. The custom cutting jigs are created by an engineer at the medical device and implant company. The quality of the resections made are therefore still dependent upon the experience of a remotely located engineer making a “best educated guess” at what will fit on each individual patient's bone structure. Clinical experience has shown that despite a detailed 3-dimensional analysis and technically advanced creation of custom cutting jigs, there are still a number of recuts that need to be made during a TKA operation.

During a total knee replacement procedure, arthritic bone on the distal end of the femur and the proximal end of the tibia is resected using intimately mounted and carefully aligned custom cutting jigs. After these cuts are made, trial implants are placed on the bony cut surfaces. Trial implants are a replica of real final implants but are not cemented into place and can be easily interchanged in order to determine the appropriate size of the final, cemented implant. The surgeon will evaluate the trial implant for alignment of the limb and range of motion of the knee. The surgeon evaluates the quality of the bony resections based on his/her clinical experience and intraoperative examination of the joint. If the joint is not performing as expected, the bone may be recut to correct any problems the surgeon perceives prior to cementing in final implants.

Although custom fitting jigs are considered to be a significant advance in TKA procedures, what initially appears to be an indicated surgical resection plan with custom fitting jigs does not always produce a successful result. Poorly performing custom cutting jigs increase intraoperative time and risk to the patient because of prolonged anesthesia. It would be highly desirable to provide an outcomes analysis method for producing custom resection jigs that would enhance a successful outcome by utilizing data from prior TKA surgeries that produced highly successful outcome results.

The limitations suggested in the preceding are not intended to be exhaustive but rather are among many which may tend to reduce the effectiveness, reliability and patient satisfaction with prior TKA procedures. Other noteworthy problems may also exist; however, those presented above should be sufficient to demonstrate that TKA surgical procedures and medical implant manufacturing processes appearing in the past will admit to worthwhile improvement.

### BRIEF SUMMARY OF THE DISCLOSURE

A preferred embodiment of the disclosure, which is intended to address outcomes analysis and comparative effectiveness concerns and accomplish at least some of the foregoing objectives, comprises the creation of a database from three dimensional images of previously performed surgeries which identifies multiple measures of joint morphology and structural alignment. This data may include implant size, limb alignment anatomical axes, mechanical axes, extension space, length and width of involved bones and other possible data points. Preoperative and postoperative subjective and objective scores and patient information are placed in the database. A subset of the database can be created that only includes patients that experienced excellent postoperative outcomes.

When a new patient needs a total knee replacement, full leg x-ray images of the patient's mechanical and anatomical bone structure is obtained as well as an MRI morphology, mapping of the opposing femur and tibia knee bone surfaces to be replaced. The current patient images and data are sent to a medical device and implant manufacturer having an extensive database of prior successful surgical outcomes. Based on highly similar to identical axis and morphology, data image recognition computer systems correlate current patient data with prior patient outcomes within a highly successful surgical database. The manufacturer then produces custom fitting jigs and implants for the current patient based on the data from prior highly successful procedures on patients with similar to identical bone data. Moreover, in some instances, because of extreme current patient bone architecture, it may be necessary to alert a current patient that the prospect of achieving a trouble free result should not be expected.

### THE DRAWINGS

Numerous advantages of the present invention will become apparent from the following detailed description of preferred embodiments taken in conjunction with the accompanying drawings wherein:

FIG. 1 is an anatomical front view segment of a human knee bone structure;

FIG. 2 is a side elevation view of the bone structure of a human knee as illustrated in FIG. 1;

FIGS. 3A-3C disclose mechanical and anatomical axes of a human leg bone arrangement where FIG. 3A is a correct vertical mechanical alignment of a human leg bone structure, FIG. 3B is an illustration of an abnormal valgus or “knock-kneed” condition and FIG. 3C is an illustration of an abnormal varus or “bow-legged” condition;

FIG. 4 is an exploded axonometric view of the major components of total knee replacement architecture;

FIG. 5 is an axonometric exploded view of a custom jig manufactured to be used in performing a distal bone resection of a patient's femur during a TKA procedure;

FIG. 6 is an axonometric view of the custom fitting jig illustrated in FIG. 5 anatomically mounted in an intimate and secure posture upon the distal end of a specific patient's femur;

FIG. 7 is an axonometric exploded view of a custom jig manufactured to be used in performing a proximal bone resection of a patient's tibia during a TKA procedure;

FIG. 8 is an axonometric view of the custom fitting jig illustrated in FIG. 7 anatomically mounted in an intimate and secure posture upon the proximal end of a specific patient's tibia;

FIG. 9 is a front view of a four-in-one cutting jig operable to be used to make an anterior cut, anterior chamfer cut, posterior chamfer cut and posterior cut on a current patient's femur;

FIG. 10 is an axonometric view of the four-in-one femur cutting jig as illustrated in FIG. 9 mounted upon the distal cut end of a patient's femur;

FIG. 11 is a partial axonometric view of opposing ends of a patient's femur and tibia following resections made using custom fitting jigs and a four-in-one jig on the femur bone;

FIG. 12 is a side elevation view of a patient's femur bone depicting in FIG. 11 with five resections and being operable to receive a metal femur implant component;

FIG. 13 is a partial axonometric view of a metal femoral component partially joined with a resected distal end of a patient's femur bone;

FIG. 14 is a side view of a patient's femur with a metal implant bearing member intimately mounted upon the distal end of a patient's resected femur;

FIG. 15 is a separated view of a generally transversely resected proximal end of a patient's tibia with a metal bearing base mounted in a generally a Y-shaped recess fashioned within the proximal end of the patient's tibia, note again FIG. 11 with a polyethylene articular bearing shown above the tibia base member prior to being joined;

FIG. 16 is an axonometric view of a TKA implant set mounted upon a proximal end of a patient's tibia and a distal end of a patient's femur with a polyethylene articular bearing positioned between the metallic bone engaging elements;

FIG. 17 is a first exemplary schematic representation of the interaction of current physician/patient data with a medical device and implant manufacturing company having a database of prior successful TKA surgeries that is designed to use data from prior highly successful surgeries to facilitate manufacture and formation of current patient custom jigs with generally transverse resection windows;

FIG. 18 is a flow diagram showing an exemplary method of creating a database to facilitate an increase in success of joint replacements;

FIG. 19 is a diagram of an exemplary search process which will generate computer recommendations for a patient based on statistically similar patients and generate a confidence factor as to the likely outcome with various design parameters;

FIG. 20 is an exemplary system diagram of a manufacturing and diagnostic system for improving the outcome of joint replacements;

FIG. 21 is an exemplary search interface showing various patient parameters which may be utilized to search a database of prior surgical parameters and associated outcomes;

FIG. 22 is an exemplary database interface showing physical parameters of the patient's joint as well as the customized prosthesis associated with that joint type;

FIG. 23 is an exemplary search interface showing results of a search which has returned statistically similar patients and which can be sorted by various parameters;

FIG. 24 is an exemplary search interface showing results of a search which returned jigs, prosthetics and customizations used on statistically similar patients and which have been sorted by successful and unsuccessful outcomes; and

FIG. 25 is a flow diagram showing an exemplary post-operative feedback mechanism which may be utilized to improve the search algorithm and recommendation engine.

### DETAILED DESCRIPTION

### Context of the Invention

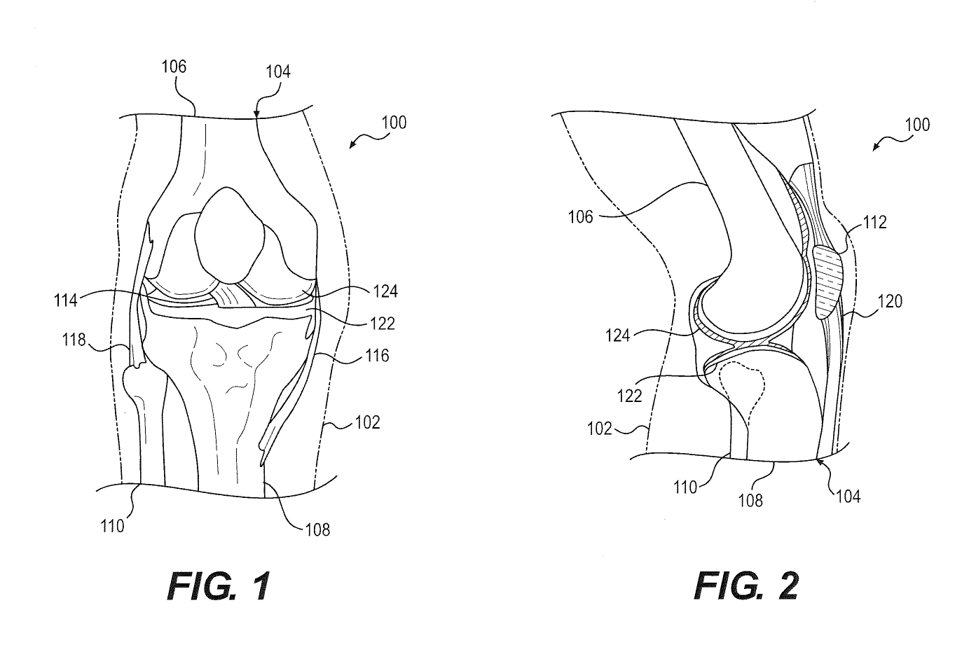

Referring now particularly to the drawings, wherein like reference characters refer to like parts, and initially to FIGS. 1 and 2 there will be seen a schematic illustration of a front and side view of the bones of a human knee joint 100. Positioned within an outer sheath of skin, muscle and connective tissue 102 is the bone structure of a knee joint 104 including a human femur 106, and an opposing tibia 108. The lower leg also includes a longitudinally extending fibula 110 and a patella 112 generally located at a frontal junction of the distal end of the femur 106 and the proximal end of the tibia 108. Tendons and ligaments hold the knee bone architecture in a flexible but secure structural relationship. In this an anterior cruciate ligament 114 extends through a central portion of the knee joint 100 and cooperates with a posterior cruciate ligament (not shown). Medial and lateral collateral ligaments 116 and 118 connect the femur and tibia and the patella 112 is supported by a patella tendon 120. Cartilage 122 exists on top of tibia and operably interacts with articular cartilage 124 covering bearing surfaces of the distal end of the femur 106.

When the cartilage 122 wears down or the cartilage surfaces 124 wear away, bone on bone contact can cause dysfunctional pain. In addition arthritic conditions of the cartilage can produce pain and discomfort. Depending upon the persistence and severity of the pain, replacement of the femur and tibia surfaces of the knee joint with inert metal replacement structures and replacement of the cartilage with a foreign cushioning material like polyethylene is a medically recognized and indicated procedure.

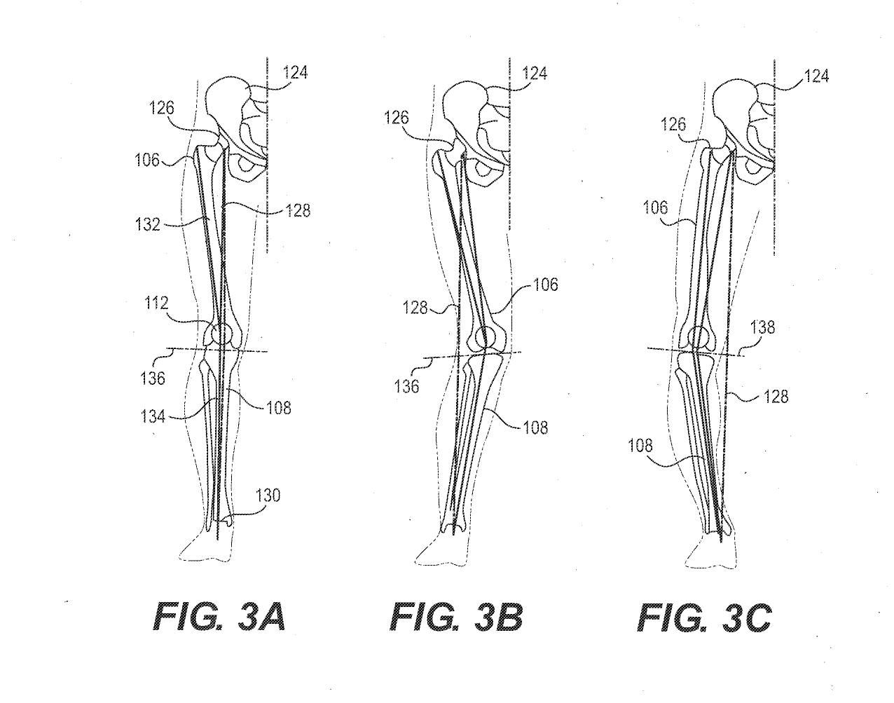

FIGS. 3A-3C represent three skeletal full leg conditions. FIG. 3A is medically considered a normal leg bone anatomy and is a desired objective following TKA. In a healthy leg posture, a femur 106 is joined with a pelvis through the provision of a hip ball joint 126 and a vertical line 128 extending through the hip ball joint also extends through the center of the knee joint 112 and center of the ankle 130. This imaginary vertical line is referred to as the mechanical axis and a proper alignment is stated as 0°. In a normal anatomy an imaginary anatomic axis line 132 along the femur forms an angle of from five to seven degrees valgus with respect to the mechanical axis 128 and an axis line 134 along the tibia is two to three degrees of varus. These values will vary somewhat for a tall person where the angle is on the low end of the range and for a short person the angle can be at the high end of the range. An imaginary line 136 drawn through the knee joint is essentially perpendicular with respect to the mechanical axis 128.

Referring now to FIG. 3B a leg anatomy is depicted where the femur 106 and the tibia 108 are decidedly valgus or “knock kneed” with respect to the mechanical axis 128. The mechanical axis 128 is lateral to the knee joint. In FIG. 3C the opposite anatomy is shown where the femur 106 and tibia 108 extend varus or “bow-legged” with respect to the mechanical axis. The mechanical axis 128 is medial to the knee joint.

In a successful total knee arthroplasty procedure, it is a goal to restore a natural range of distal femur and proximal tibia anatomy as noted above a 0° mechanical alignment and a joint line which allows proper functioning of preserved ligaments, balanced ligaments and maintaining a proper Q angle to ensure proper patellofemoral tracking

### Total Knee Arthroplasty

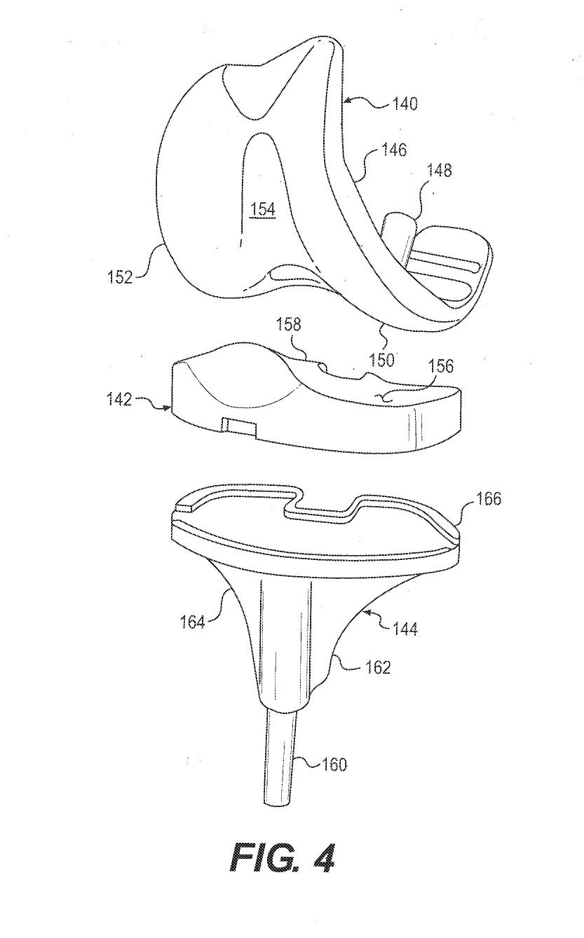

FIG. 4 discloses the major components of a total knee arthroplasty (“TKA”) prosthesis. A total knee arthroplasty prosthesis set typically includes a femur component 140, a bearing 142 and a tibial component 144. The femur component 140 has an interior surface configuration 146 that is shaped to match identically with five femur resection cuts as will be discussed below. An interior surface of the femur component 140 also includes a pair of lugs 148 that extend normally from a femur distal surface of the femur component and operable fit within cylinder voids fashioned within a patient's femur. An exterior surface of the femur component comprises a pair of laterally separated bearing surfaces 150 and 152 that are smoothly arcuate in three planes and are separated by a trochlear groove 154 that closely approximates the exterior distal femur surface of the human knee it is designed to replace. The femoral component can be fabricated from a number of different material compositions or alloys such as a chrome cobalt alloy or oxidized zirconium.

A second major component in a TKA prosthesis is a bearing 142 that is typically fabricated from a polyethylene or similar composition. The bearing 142 includes a pair of arcuate bearing surfaces 156 and 158 which cooperate with the arcuate bearing surfaces 150 and 152 of the femur component. A distal surface of the bearing 142 is generally planar and is designed to be stably received within the tibial component 144. The tibia component is composed of a medical grade alloy and has a longitudinal keel 160 that is flanked by a generally V-shaped braces 162 and 164 which and designed to extend longitudinally into a patient's tibia as will be discussed below. A peripheral rim 166 encircles an upper edge of the tibia component and is dimensioned to intimately cooperate with the base of the bearing 142 to orient and lock the bearing 142 with respect to the tibia 108 of a patient.

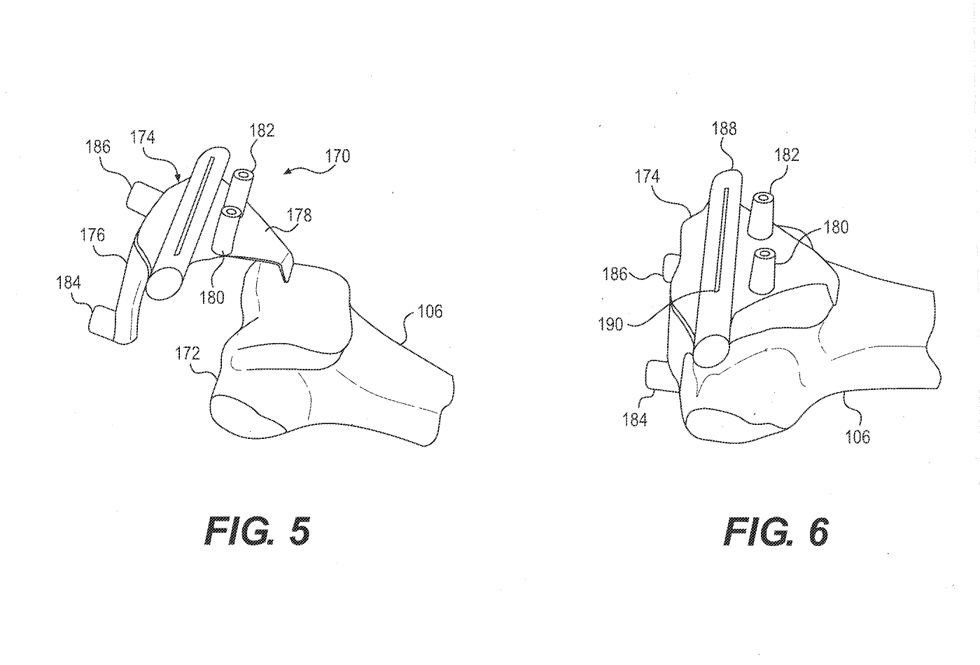

FIGS. 5 and 6 disclose a custom fitting jig 170 for the distal end of a specific patient's femur 106. It will be appreciated that the distal morphology 172 of a specific patient's femur will be generally the same as other humans but significant differences usually exist. As an example the age and/or gender of a patient can have an effect on distal morphology, varus or valgus axis alignment, disease, patient occupation wear, etc. all can affect a current patient's morphology. In order to make an initial, generally transverse resection to the distal end of a patient's femur, however, MRI or CT imaging, with or without a full leg X-ray, enables medical device manufacturers to accurately map the distal femur morphology of a current patient along with mechanical and anatomical leg axis data. This information is then used by the medical device company to produce a highly accurate internal surface of a distal jig 170 for a specific patient. The technology to produce custom fitting distal jigs for a femur is known by medical device manufacturing companies and their suppliers. One previously known practice and procedure for producing custom arthroplasty jigs is disclosed in United States patent application publication US 2010/0023015 assigned to OtisMed Corporation of Alameda, Calif. The disclosure of this United States published application is incorporated herein by reference as though set forth at length as one way of producing a custom femur resection jig.

The distal, custom femur jig 170 comprises a body portion 174 that includes a generally transverse segment 176 and a generally normally extending front segment 178. The front segment includes a pair of tubular columns 180 and 182 that are operable to receive medical grade retention pins (not shown) that releaseably secure the custom jig 170 to a femur as depicted in FIG. 6. As noted above the morphology of the current patient distal end of the femur is identically matched by an interior surface of the custom jig 170. Accordingly the jig 170 as designed for and specifically conforming to the bone morphology of a specific patient serves as a basis for a fixture specific to a particular patient and fitting a specific posture at the distal end of a patient's femur.

Integrally formed within the custom fitting jig, body portion 174 is a femur resection guide 188 having a slit window 190 opening that extends transversely into the body of the jig 174. The window serves to receive and guide a cutting blade of a surgeon's resection saw. The resection window is accurately oriented by a medical device manufacturer with a specific three dimensional cant to guide a distal resection cut that will correct axial alignment of the specific patient's femur. This window orientation is designed by a medical device manufacturer to account for femur/tibia gap spacing as well as axial alignment as engineered for a specific patient based on the patient's MRI and radiology axis data.

The custom distal jig 170 is typically manufactured from a medical grade nylon composition that is suitable to exhibit rigidity in the environment of human body fluids. Moreover, in some instances it may be desirable to line the generally transverse, custom, distal resection window with a metal lining to insure accuracy of the resection saw distal femur cut. Further, in some instances the custom jig may be used mainly to set the position of the retention pins and another metal cutting jig may be placed over those pins to guide the resection.

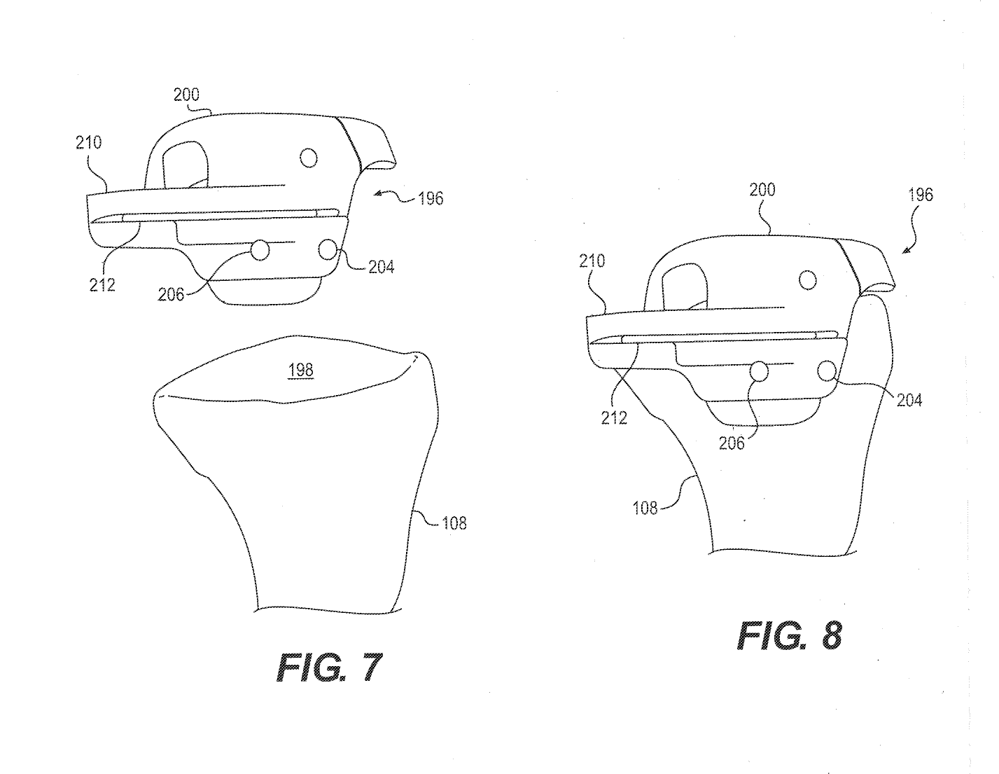

Turning now to FIGS. 7 and 8, there will be seen images for a custom tibia jig 196 that is similar in many respect to the custom femur jig shown in FIGS. 5 and 6. In this the purpose of the custom jig 196 is to produce an accurate generally transverse resection of a patient's tibia with proper longitudinal spacing from the patient's distal femur cut and generally transverse to the patient's mechanical axis. In order to accomplish is function, MRI and axis data for a specific patient is used to map the morphology of the patient's proximal end of the tibia 198 and this information is used to fashion the interior geometry of the custom tibia jig 196.

The custom tibia jig 196 includes a body 200 that is operable to be mounted upon a generally transverse proximal end of a specific patient's tibia 108. As noted above, the interior surface geometry of the custom tibia jig 196 matches the morphology of the patient's tibia so that the jig fits intimately onto a proximal end of a specific patient's tibia. Medical grade pins extend through apertures 204 and 206 to firmly secure the custom tibia jig 196 onto the tibia. In a manner similar to the custom femur resection jig 170, integrally formed within the body portion 200 of the custom fitting tibia jig 196 is a tibia resection guide 210 having a resection slit or window 212 opening that extends generally transversely into the body of the jig 200. The window 212 serves to receive and guide a cutting blade of a surgeon's saw. The resection window 212 is accurately oriented by a medical device manufacturer with a specific three dimensional cant which is essentially perpendicular to a mechanical axis of the patient's tibia to guide a proximal resection that will correct, in combination with the distal femur cut, mechanical and anatomical alignment of the specific patient's leg. This window orientation is further designed by a medical device manufacturer to account for a femur/tibia gap spacing as well as axial alignment that was engineered for a specific patient based on the patient's MRI and axis data.

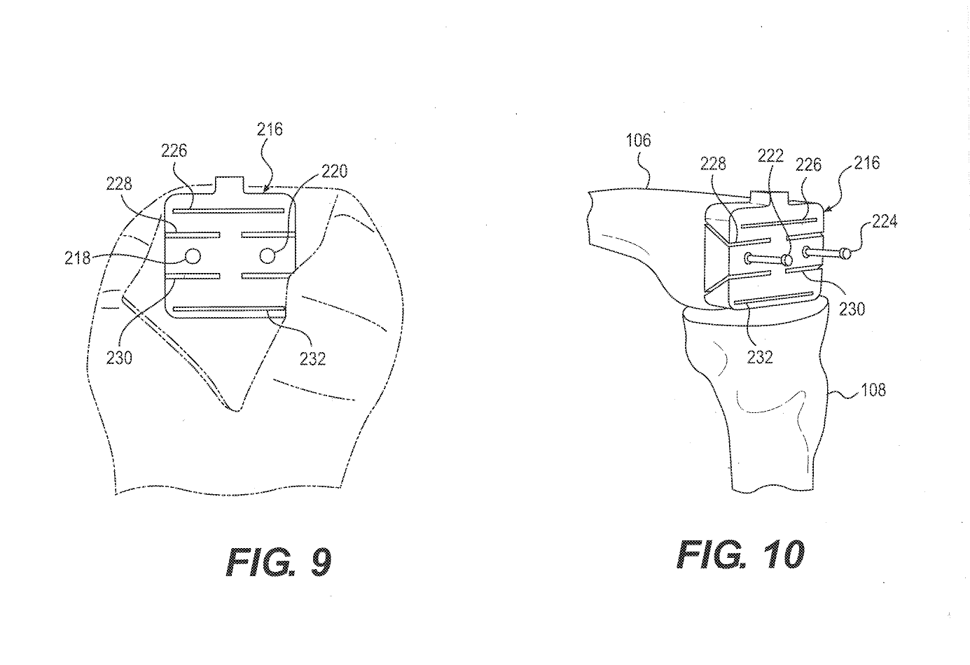

FIGS. 9 and 10 illustrate a four in one resection jig 216 that is mounted upon a patient's femur 106. The four in one resection jig 216 is chosen from a library of approximately eight standard sizes and includes a pair of mounting apertures 218 and 220 that are in alignment with the holes drilled in the patient's femur through guide columns 184 and 186 respectively in the custom resection jig 170 (note again FIG. 5). The four in one jig is firmly held in the position dictated by the position of the holes formed through the custom fitting femur jig 170 by insertion of a pair of pins 222 and 224 as illustrated in FIG. 10 into the alignment holes in the femur. The four in one jig 216 has four resection windows—(1) an anterior cut window 226 extending generally parallel with an anterior portion of the distal end of the patient's femur, (2) an anterior chamfer window 228, (3) a posterior chamfer window 230 and (4) a posterior cut window 232.

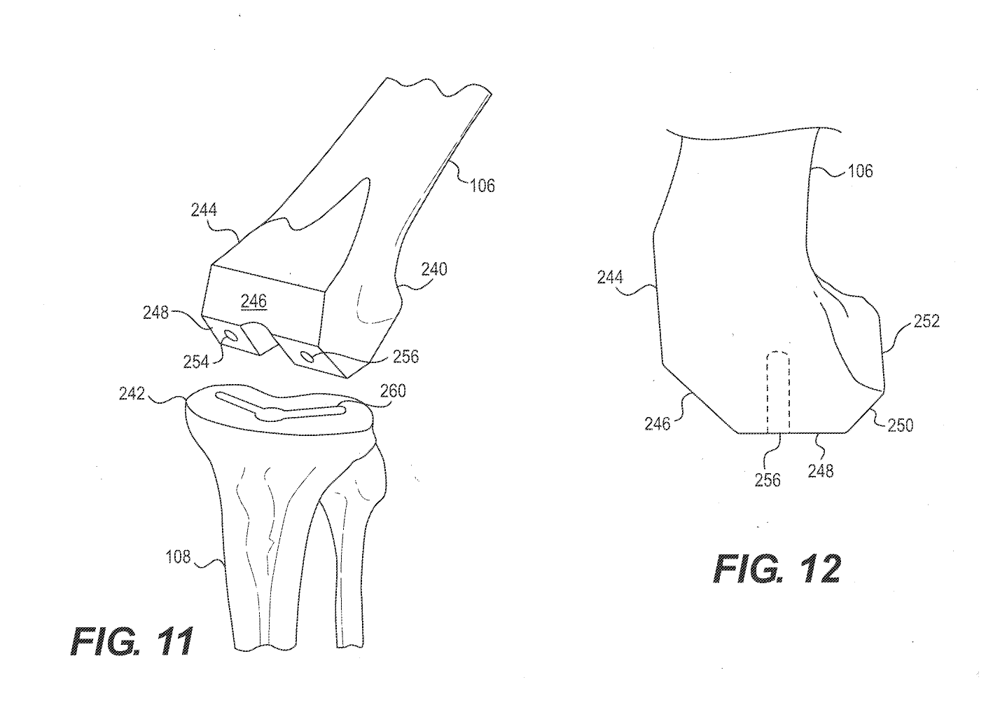

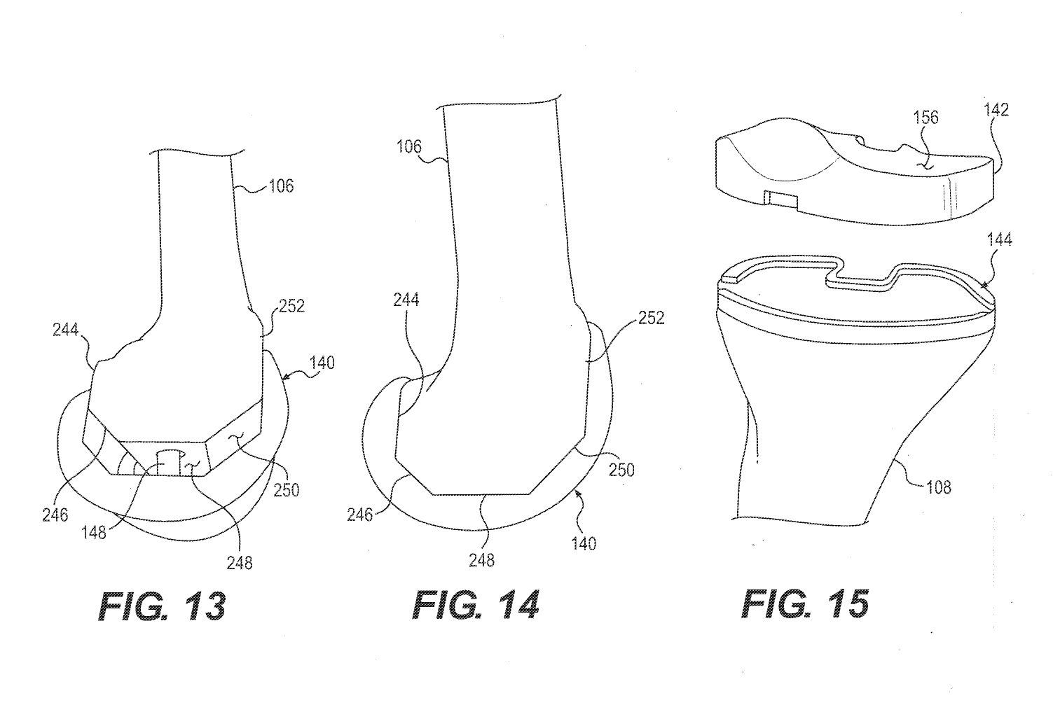

FIG. 11 discloses the distal end 248 of a resected femur 106 and the proximal end 242 of a resected tibia. At the distal end of the femur, an anterior cut surface 244 is shown that extends substantially parallel with the femur 106. Another cut that is made is an anterior chamfer surface 246. The distal generally transverse cut 248 is formed by the custom fitting femur jig 170. Further, a posterior chamfer cut 250 is made and a posterior cut 252 that is essentially parallel with the anterior cut 244. The custom fitting femur jig 170 establishes the posture and orientation of five femur resection surfaces with the aid of a standard size four in one jig 216. The longitudinal holes in the femur 106 formed with the custom fitting jig 170 are used by the four in one jig 216 and will be used to secure a femur prosthetic component (note now FIGS. 12 and 13).

Following bony resections and test fitting of a temporary femur prosthesis, a final femur prosthesis component 140 is mounted upon the distal end of the femur and cemented in place as shown in FIG. 14. In a similar manner, following a test fit, a tibia prosthesis component 144 is mounted within a generally V-shaped void 260 created in the proximal end of the tibia (note again FIG. 11). The thickness of the polyethylene or other composition bearing 142 was determined by the medical device engineer from MRI and radiology data for a specific patient and the bearing is locked into the tibia component 144.

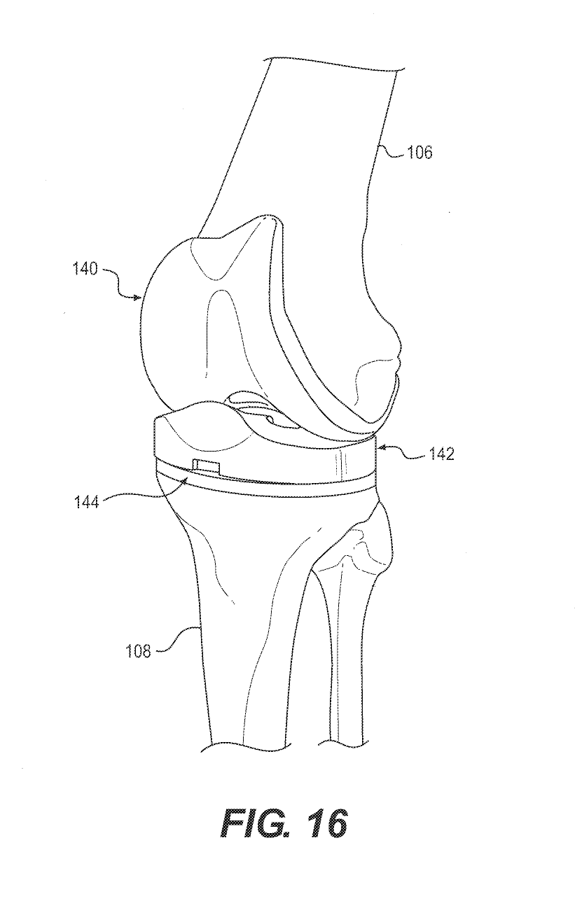

Turning now to FIG. 16 a completed total knee arthroplasty prosthesis is shown positioned between a resected distal end of a patient's femur 106 and proximal end of the patient's tibia 108. A posterior cruciate ligament retaining implant is depicted. The disclosure, however, also fully applies to a posterior cruciate ligament sacrificing TKA procedure as well. All of the components were accurately engineered and placed by a physician according to a surgical plan that is provided by a medical device manufacturer in preoperative consultation and planning with a physician schedule to perform the surgery. Although preoperative planning, collecting MRI and radiology data and manufacturing a custom distal femur jig 170 and a custom tibia jig 196, in clinical practice surgeons frequently find it necessary or desirable to make adjustment cuts to facilitate optimal axial alignment and full knee range of motion.

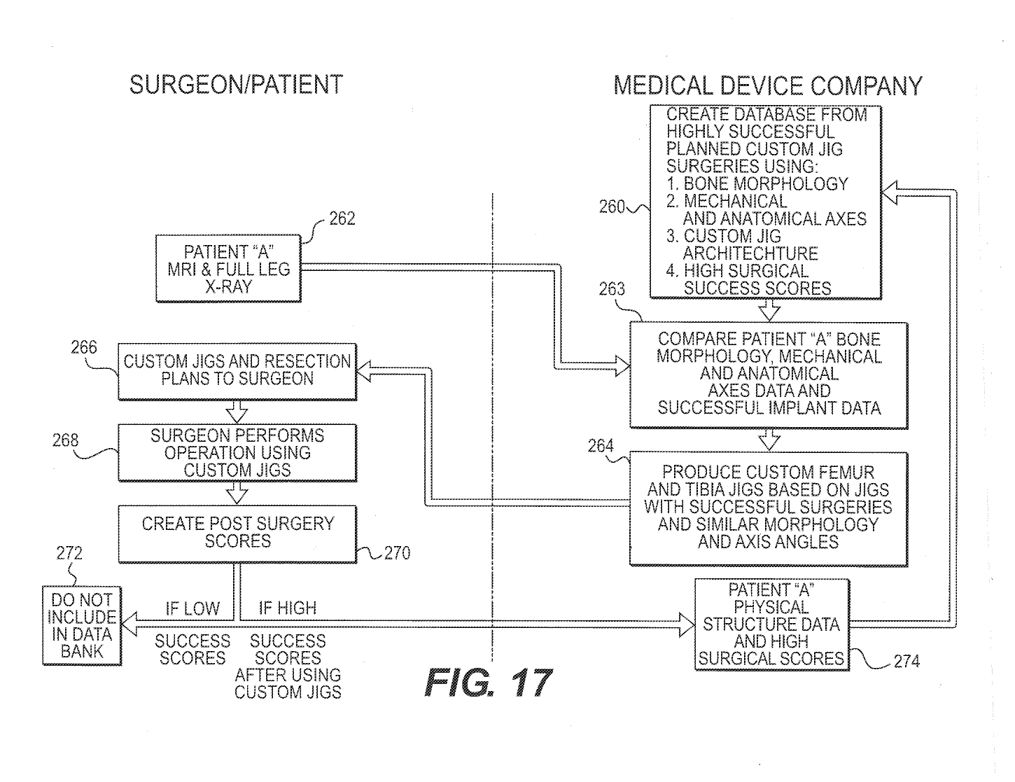

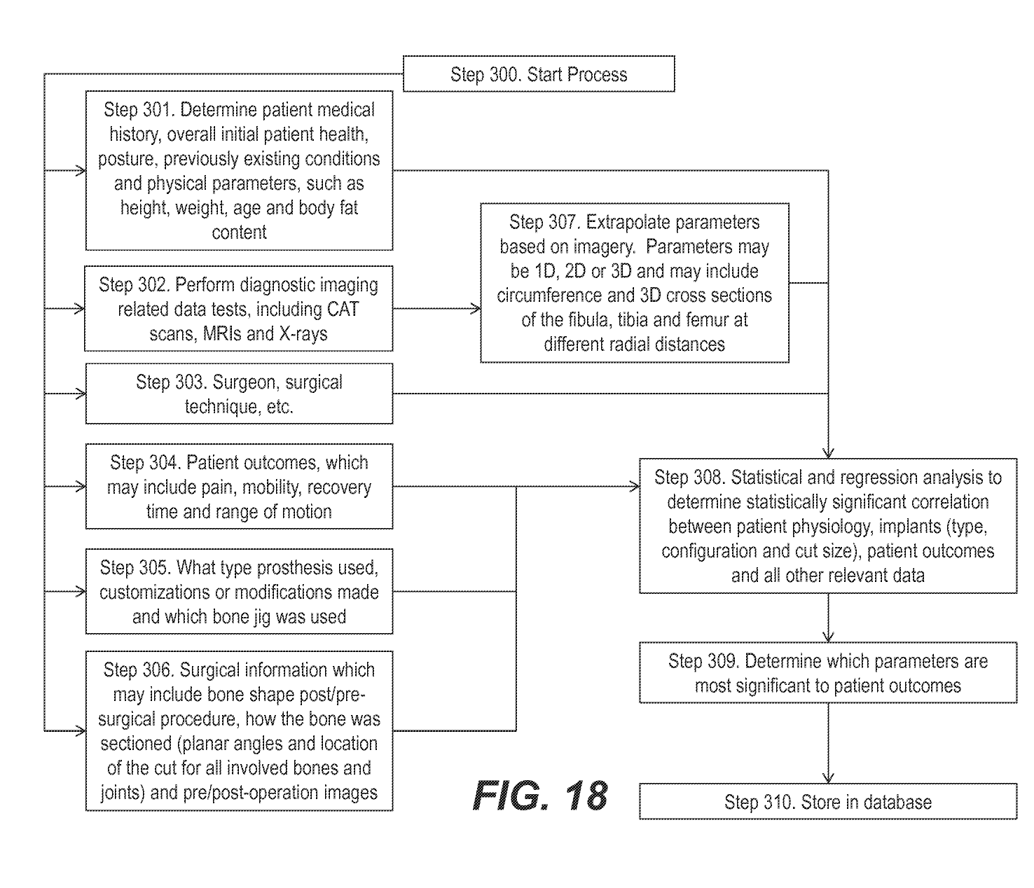

Exemplary embodiments of flow charts implementing aspects described herein will now be described. Referring now to the flow diagram depicted in FIG. 17, an activity stream for a surgeon/patient and a medical device and prosthesis manufacturing company is shown. A medical device company maintains a database of prior TKA procedures using the company's custom jigs and prosthesis products. Within that data base is the geometry of custom jig resection windows 190 and 212 coupled with patient bone morphology and mechanical and anatomical axis data. A subset of the data within the database for data records of medically recognized successful prior surgical outcomes.

In the medical profession orthopaedic scoring is a recognized procedure for measuring surgical outcome effectiveness. With respect to TKA procedures a clinician may complete a Knee Society Score (KSS). This scoring process included two parts: (1) a knee score and (2) a function score. The KSS includes grading elements of pain, range of motion, and stability, with possible deductions for flexion contracture, extension lag, and malalignment. Based on these criteria components, grading for a post-operative TKA is recorded and a score of 85-100 is considered “excellent” and a score of 70-84 is considered “good”. In addition, a Function score is considered which includes walking and stair climbing with deductions for reliance on walking aids.

Another clinician completed scoring tool is the Hospital for Special Surgery Knee Score (HSSKS). The HSSKS includes grading elements of pain, function, range of motion, muscle strength, flexion deformity, instability, with possible deductions for dependence on walking aids, extension lag, and varus/valgus deformity. Based on these criteria components, grading for a post-operative TKA is recorded and a score of 85-100 is considered “excellent” and a score of 70-84 is considered “good”.

In addition to clinician completed scoring, patient completed scoring is also frequently utilized. In this there are at least three medically recognized patient completed scoring regimens that are available (1) an Oxford Knee Score; (2) Knee Injury & Osteoarthritis Outcome (KOOS); and (3) Western Ontario and McMaster Universities Osteoarthritis Index (WOMAC) score.

An Oxford Knee Score includes twelve subjective patient questions with five levels of response from most desirable (5) to least desirable (1). These scores can be recorded pre-operative and post-operative for outcomes analysis and comparative effectiveness. An Oxford Knee Score greater than or equal to 40 is considered excellent and such a score would be a basis for consideration of inclusion of that particular patient's jig design for his/her bone data being entered into a manufacturer's database of a successful outcome.

A Knee Injury & Osteoarthritis Outcome (KOOS) scoring regimen includes questions for symptoms, stiffness, pain, physical function that affects daily living, physical function that affects recreational activities and quality of life scores. Collectively these result in a KOOS outcome score that can be pre and post-operative comparative or just an absolute post-operative value that can be used as a outcome determining factor for inclusion of a particular custom jig window design into a manufacturer's database for future use in producing custom jigs. A KOOS score of 85% is considered excellent and can serve as a basis for directing inclusion of a patient's jig window geometry into the manufacturer's database.

A WOMAC score includes elements of symptoms, stiffness, pain, and function (daily living). A WOMAC score of 85 or more is considered excellent and as a result if a patient has a post-surgery WOMAC score of 85 that patient's bone morphology, axis data and custom jig window design is entered into the manufacturer's database.

The process of creating and maintaining a database of highly successful or successful TKA surgical results for company custom jigs and prosthesis is represented by step 260 in FIG. 17.

Referring to step 262 a surgeon examining a potential current patient orders an MRI or CT scan to be taken and possibly a full leg X-ray of a patient's leg for knee bone morphology and mechanical and anatomic axis data. This information is then transmitted to a medical device company where the data is compared with all prior patient data from successful or highly successful TKA procedures recorded within the company's database as noted in box 263. Next, the manufacturing company produces a custom fitting femur and tibia jig, such as jigs 170 and 196 respectively, based not only on bone data per se but also on outcomes scores that are recorded in the company's data base.

The medical device company then manufactures the custom femur and tibia jigs, prepares with the surgeon a surgical plan and forwards the jigs, surgical plan and TKA prosthesis components to the surgeon, note box 266. The surgeon then performs the surgery using the custom fitting jigs with specific resection windows for the specific patient based on the specific patient's bone morphology and axis data and the company's database of custom jig window configurations for prior highly successful surgeries.

The surgeon or his/her medical team then determines post-surgery clinical and patient completed TKA scores as discussed above—note step 270. If the scores are low or problematic or recuts were required, the patent's data is not forwarded to the medical device company's data base but rather is analyzed for a surgeon's information and consideration for further surgical and/or physical theory work. If, on the other hand, the post-surgery TKA scores “Excellent” or at least “Good” the patient bone data and jig design data is returned to the medical device company, note step 274, and the data is added to the company data base for use in future manufacture of custom jig designs.

Referring to FIG. 18, step 300 is an exemplary method for the creation of the database. Patients who have already received joint replacement such as TKAs and have gone through various post-procedure diagnostic measures, including x-rays, as well as an evaluation of their patient outcomes, may have their surgical data collected, categorized, and/or input into a database. Data useful for various aspects of the database can be found in steps 301 through 306. If the data is imaging related, it may be necessary to extrapolate some parameters before inputting the data into the database. All patient information should be entered into a database and then a computer will run a statistical and/or regression analysis of the data to determine correlation between patient parameters, the equipment/technique, prosthetics utilized, prosthetic customizations and/or outcomes (as shown in step 308). The computer may also be programmed to determine which parameters are most significant to patient outcomes (step 309) through correlation algorithms. Data and computer analysis may be stored in a database which can later be utilized for surgical recommendations to increase confidence in a desirable patient outcome.

In some embodiments, the computer employs statistical and/or regression analysis to analyze the above mentioned data and return a recommendation as an output. In this example, regression analysis may be used to determine which patient parameters affect patient outcomes and to what extent changing various parameters such as jigs, jig angles, prosthetics and other medical devices/customizations will affect these outcomes. For example, if there are many different patients who all have identical patient parameters and if, during their surgeries, the jigs, prosthetics, medical equipment, surgical techniques etc. are varied those parameters which are statistically significant in determining patient outcome may be determined. Further, the data set may be improved by forming a surgical reference model for use on patients with certain parameters and then varying one variable while some, most, or all other variables are held constant. An example would be to vary the angle on a cut in the jig and/or the thicknesses of inserted polyethylene. The computer may then variously analyze the resulting data using an appropriate algorithm such as regression analysis to determine whether or not the modified variable affected patient outcomes. Using post-operation evaluations, the computer may evaluate the extent to which the modified variable patient outcome such as pain level, function, range of motion, or any other desired parameter. Thus, the computer may make recommendations that are much more consistent than those currently available. The computer also may use this information to determine a recommendation for the appropriate surgical parameters such as jig model, prosthesis, surgical technique, and various customizations to the foregoing. The doctor may be given an opportunity to review, modify, and/or propose alternate surgical parameters.

In a further exemplary embodiment, regression analysis in accordance with the formula Y≈f(X, β), where Y is the dependent variable, X is the independent variable(s) and β is the unknown parameter may be utilized to determine the surgical parameters given the patient parameters as modified with respect to known preferences for a particular doctor and/or medical practice and/or with doctor feedback. For example, this regression algorithm may be implemented using a least square analysis in a manner in accordance with the following algorithm:

$${β}_{1} = \frac{\sum ( {x}_{i} - \overline{x} ) ( {y}_{i} - \overline{y} )}{\sum {( {x}_{i} - \overline{x} )}^{2}}$$

$$and$$

$${β}_{0} = \overline{y} - {β}_{1} \overline{x} .$$

F-tests and t-tests may be performed to determine the statistical significance of the surgical parameters given a set of patent data within a defined range and an R-squared test, may be used to assign weight to the importance of this particular parameter in patient outcomes. This weight may be used later when the computer is required to give recommendations regarding a new patient's surgical parameters such as prosthetic, jig, etc. Once the computer has determined either one or a set of appropriate surgical parameters (including, for example, any doctor preferred procedures and/or parameters), the computer may then provide estimates for various patient outcomes for each scenario.

In still further embodiments, other algorithms may be used in a manner similar to the above instead of or in addition to the above algorithms. For example, the Pearson product-movement correlation coefficient formula is defined as

$${ρ}_{x , y} = \frac{E [ ( X - {μ}_{Y} ) ( Y - {μ}_{Y} )}{{σ}_{x} {σ}_{y}} ,$$

where X and Y are random variables, μₓ and μ_{y} are expected values, σₓ and σ_{y} are standard deviations and where E is the expected value operator. In this example, the Pearson correlation formula outputs values between −1 and 1 and these values indicate the kind of relationship between two variables (linear correlation, negative correlation or unrelated) and the degree of the relationship. In certain circumstances, this algorithm may be particularly useful because it gives the degree of the relationship and this degree may be calculated into the computer's analysis as a weight value when the computer is later required to give recommendations regarding a new patient's surgical parameters.

In still further embodiments, the Spearman's rank correlation analysis and the Kendall tau rank correlation analysis can be utilized either alone or in conjunction with the above algorithms. These algorithms provide an indication of the extent to which the increase of one variable causes another variable to decrease. Of course the above algorithms are not exhaustive and there are other techniques known to those skilled in the art which may useful in the analysis discussed above.

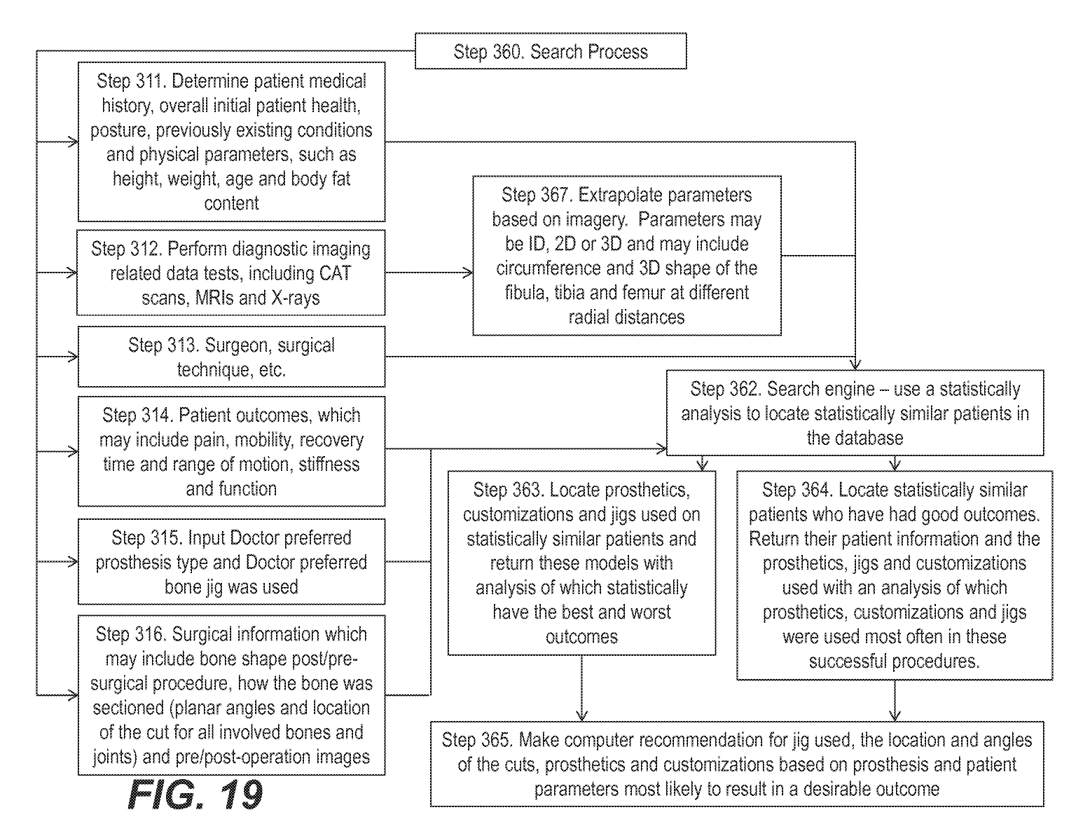

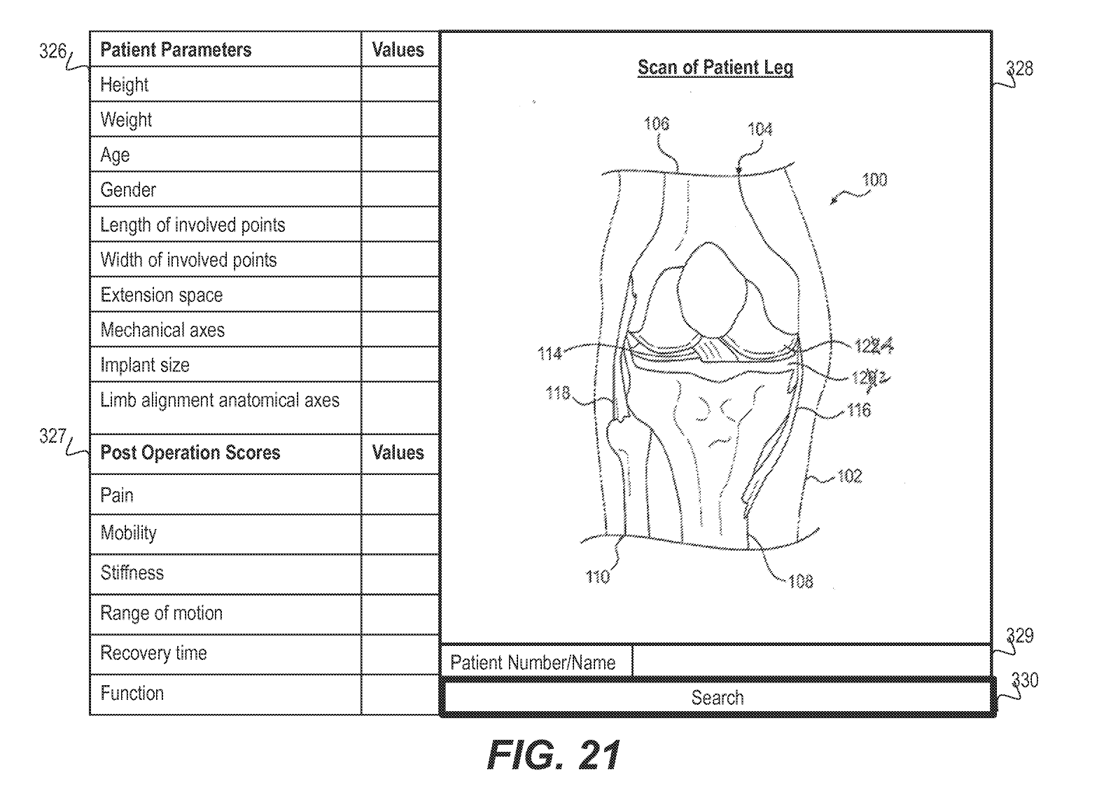

Referring to FIG. 19, an exemplary search process of the patient outcome database is provided. The process is initiated with input to the search process (step 360). A graphical interface such as shown below in FIG. 21 may be utilized to determine portions of the input to the search process. This information may be input to the search algorithm as in step 311. In step 311, patients who are scheduled to receive a joint replacement may have their patient parameters and other physical data collected. Exemplary data which can be useful for the search can be variously configured. Exemplary data is shown in steps 311-316 and 367. Step 314 can be included in the search if the patient wishes to specify which of the patient outcome criteria are viewed as a priority in the surgery. For example, if one technique has less pain but more recovery time, the patient may opt for this method. Another technique might have a greater range of motion, but more recovery time. If the data is imaging related, it may be necessary to extrapolate some parameters before inputting the data into the database. Patient information should be entered into the database. A computer will use previously determined statistical and regression analysis of the data to analyze this data (step 362) and return recommendations on the prosthetics, customizations and jigs that will most likely result in the best or worst patient outcomes. The analysis should be a fuzzy analysis—for any given parameter the user should be able to specify a range of data which will also be included in the analysis. For example, patients who weigh 180 pounds should be grouped with other patients whose weights are similar but not exactly the same. The user will be able to determine the size range and include patients who are 175-185 pounds or whatever weight range they deem appropriate. This exemplary search method can be organized in various ways. Two of the exemplary ways are shown in FIG. 19. Step 363 shows a method in which the computer analyzes each of the different types of jigs, prosthetics and customizations available and returns the models which have statistically the best, worst outcomes and/or the percentage of successful/unsuccessful outcomes for various models, customizations, and/or techniques associated with statistically similar patients. Step 364 shows another exemplary method in which the computer locates statistically similar patients who have had good outcomes (patients may be categorized as having good outcomes if they receive a certain minimum rating in their clinician and patient completed evaluations). The computer will then return the patient information and indicate which prosthetics, jigs, customizations, etc. were used most often in these successful operations. The physician/engineer/technician may then link to the imaging and patient information associated with those patients. Either search method allows the user to prioritize patient outcome categories or patient parameters in such a way that these categories or parameters will carry more weight than the others. For example, the doctor may have a great deal of experience working with a particular prosthesis and may wish to weight this more heavily in his search criteria. The weight will be input into the algorithm to determine the appropriate recommendations based on patient and/or surgeon priorities. Additionally, the algorithm may be customized to a particular surgeon and/or surgical technique to return the most successful prosthesis and/or prosthesis customization based on the surgeon's and/or surgical technique's past performance and/or results.

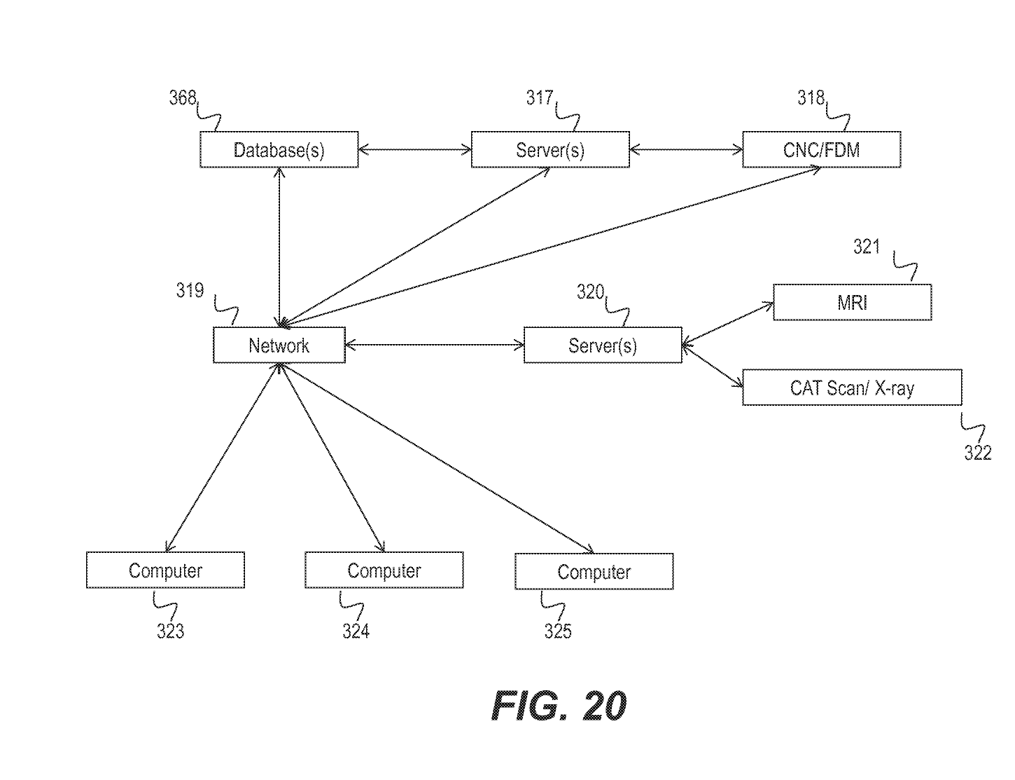

FIG. 20 is a block diagram of an exemplary system and apparatus. For example, computer(s) 323-325 may be disposed remotely such as in one or more doctor's offices. The computers 323-325 may be servers, desktop computers, graphic work stations, and/or computer networks embodying other computers. Network 319 may be variously configured to include a private network, a virtual private network, the Internet, and/or any combination of the foregoing. The imaging center may be variously configured. For example, the imaging center may comprise imaging devices such as CAT scan/x-ray 322 and/or magnetic resonance imaging (MRI) 321. The imaging center may be connected directly to server(s) 317 (connection not shown in drawing). Alternatively, the imaging center may be connected directly to one or more of the computers 323-325 (connection not shown in drawing). Additionally, the imaging center may have one or more servers 320. These servers may be variously configured such as by connecting to the network 319. Database 368 may be connected to network 319, server(s) 317 and/or server(s) 320 (the last connection not shown in drawing). The database may store patient information, surgical information, patient parameters and images obtained from server(s) 320, computers 323-325 or network 319. This information will likely contain, but is not limited to, some or all of the information described above in the flow diagrams (FIGS. 18 and 19), e.g., in steps 301-306 and 311-316. Server(s) 317 may process information in a manner similar to that found in FIGS. 18 and 19 in order to create and/or search the database. Server 317 may obtain the information necessary for the creation and/or search of this database through various sources, which may include server 320, network 319, database 368 and computers 323-325. Once the information is processed, server 317 may store the information in database 368 and/or send results and recommendations to network 319, computers 323-325 or one or more modeling/milling machines such as a computer numeric control CNC device, computer aided manufacturing (CAM) device and/or a rapid manufacturing/prototyping machine such as a fused deposited modeling (FDM)™ device 318. Materials used in forming the prosthesis and/or the jig for cutting the bones may be formed using, for example, nylon 12, acrylonitrile butadiene styrene (ABS) polymer, polycarbonates, polycaprolactone, polyphenylsulfones, thermoplastics ABS, ABSi, polyphenylsulfone (PPSF), polycarbonate (PC), Ultem 9085, and/or various metals and alloys. Machine 318 may be any machine equipped to make the medical equipment necessary for the joint replacement operation in question. This machine may receive recommendations and specifications for the design of the desired medical equipment from server 317 and may require approval from an engineer/doctor/technician before processing can be completed. In certain exemplary embodiments, a process flow is setup so that all customizations are first approved by a qualified engineer, technician and/or the doctor placing the order.

FIG. 21 is an exemplary search screen interface, e.g., a screen shot of a potential database search window. Various profiles may be utilized in the search such as patient parameters 326 and/or post-operative scores 327. These profiles can be used to construct a search profile for a new patient. Search criteria box 326 shows various physical parameters. One or more of these parameters may be input into the system search in order to facilitate proper correlation between the current patient and past patients in order to increase the probability that the computer returns a recommendation appropriate for the patient physiology, the preferred prosthesis, the chosen medical technique and/or the doctor preforming the surgery. Other parameters which may be included in this section of the search are, for example, found in FIG. 19, steps 311 through 313 and steps 315 through 316. The search values may be particular values and/or a range of values to implement a “fuzzy” search for patients with similar characteristics within a range. For example, the search may have the individual's actual weight and/or a range of values similar to the patient's weight, used to broaden the search and return a more inclusive recommendation. In another embodiment, the user may be able to access an options menu where they can specify ranges and weights for different parameters before beginning a search. Search criteria 327 may include items such as the desired post operations scores. With respect to the patient parameters 326 and/or the post-operative scores 327, various weights may be associated with each of these such that the search is more heavily weight toward one or more parameters. For example, if the patient has indicated that certain outcomes such as recovery time are priorities, the search may be more heavily weighted to this outcome parameter allowing the search to give more weight to this category when searching for results. Box 328 shows search criteria found in imaging related data, such as CAT scans, MRIs, x-rays or any other images of the relevant joint, bone(s), and/or posture such as knocked knees and/or bowed legs. It may be desirable to extrapolate various parameters from these images using computer algorithms before a search can be performed such as cross sectional profile at various radial distances, angles of approach, and/or bone density. It may also be desirable to search on a particular patient 329 who, for example, has had a joint replacement before and needs adjustments or who is closely related to another patient with identical parameters. Hence, it may be desirable to include a search option to look for a specific patient by name or identification number in the search interface. There may be a button or command 330 which will initiate the search and analysis.

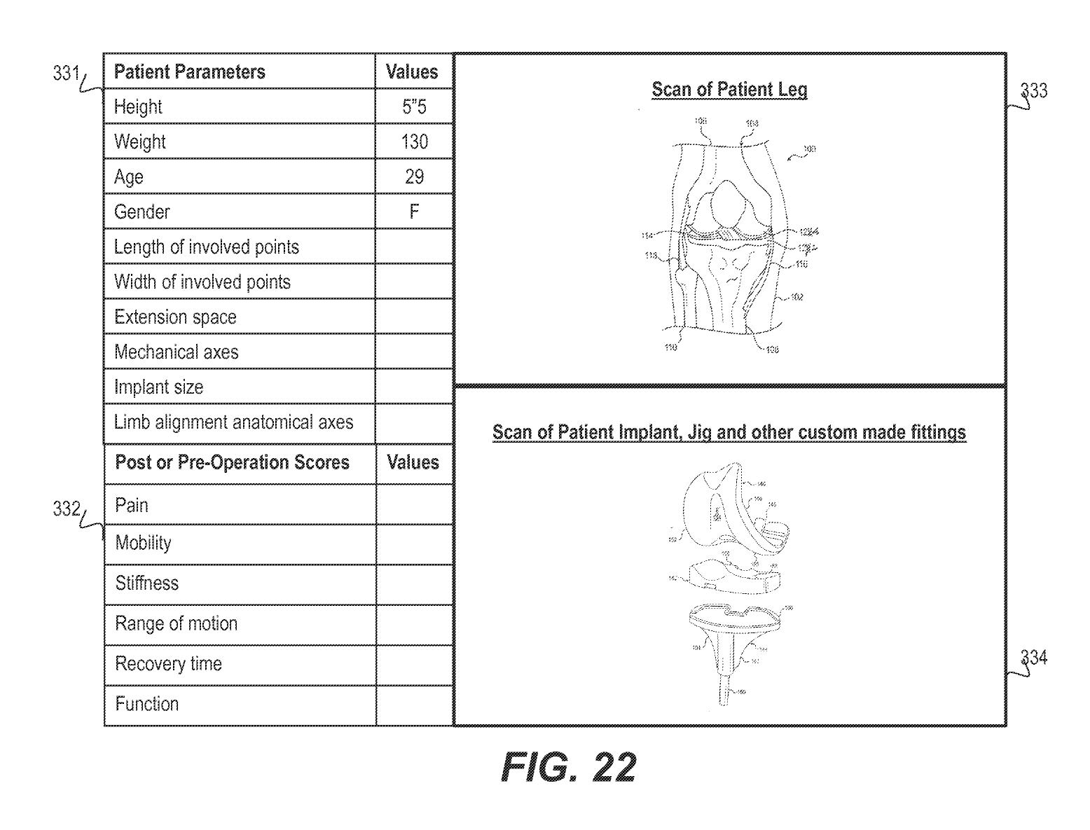

FIG. 22 is an exemplary database screen interface showing the database information for a particular patient. Patient parameters 331 and 332 indicate the different parameters which would be gathered for the patient pre and post-surgery. Other parameters which may be included in these sections are found in FIG. 19, steps 311 through 316. For example, pre and post-operational images 333 of the patient and could also include other parameters extracted from these images, including the change in limb alignment before and after the surgery. Additional parameters, such as the jigs and prosthetics 334 designed for and/or used in the joint replacement operation, may also be gathered. This section may also include customizations and modifications made by the surgeon during the procedure and/or any notes associated with the operation.

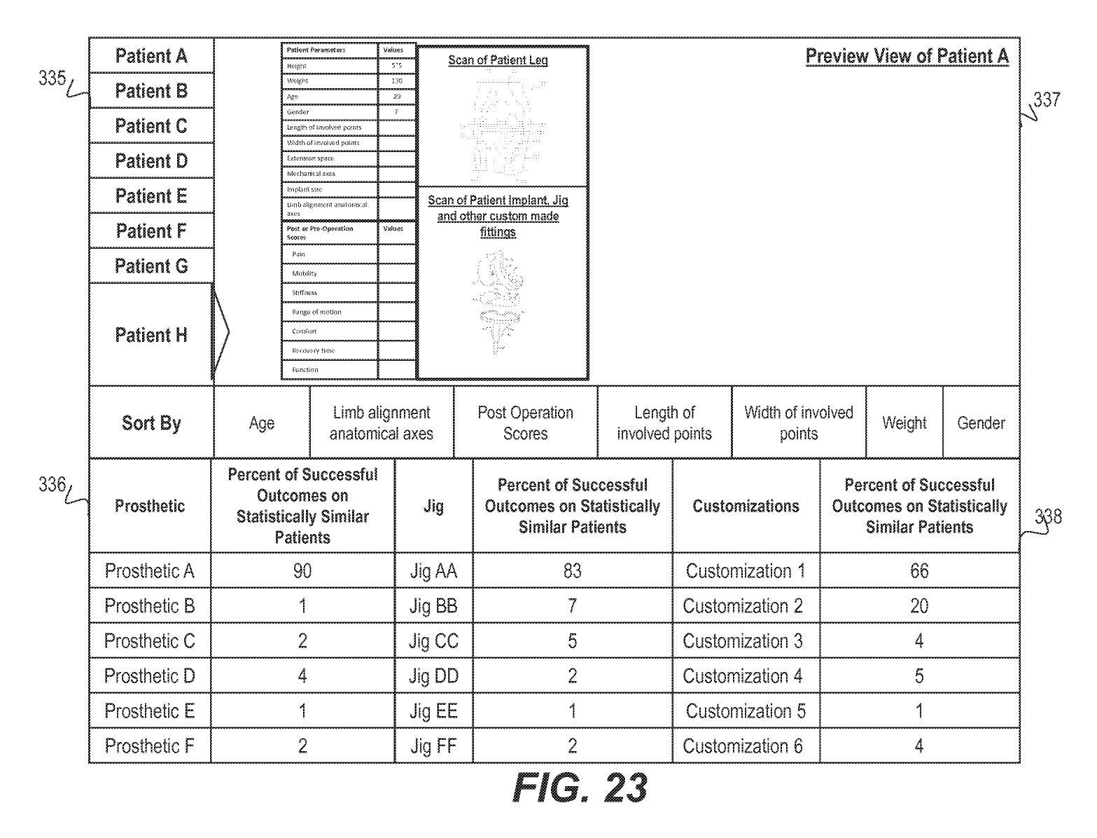

FIG. 23 is an exemplary database screen interface showing one method for sorting the results of the computer analysis and recommendations. This method corresponds to step 364 (see FIG. 19) where the search locates statistically similar patients with good outcomes and then analyses only these patients. The search may return a screen like the one in FIG. 23, where specific patients who are statistically similar are listed (box 355) and who have had good outcomes. Information belonging to each specific patient can be previewed in the box 337, where the information shown is similar to the exemplary patient information screen interface found in FIG. 22. The specific patients can be sorted 336 by various parameters as desired by the user. The parameters used for sorting can include medical parameters or patient priorities (see steps 311 through 316 in FIG. 19). Section 338 indicates the prosthetics, jigs and customizations used on the similar patients (previously determined and displayed on screen portion 335). Sections listing a medical device or customization used may have a corresponding column which indicates how often these prosthetics were used in this particular set of patients. Images of the prosthetics, jigs and customizations may also be included in this section.

Automated and computer assisted pre-operative planning can improve joint replacement outcome. The computer assisted pre-operative algorithms may be used to recommend correction of angular deformities and determine the size of an implant for each individual patient customized to accommodate the size and shape of their individual bones. For example, in knee replacement, a regression analysis based on past operational data may recommend one of approximately eight different size femoral components and approximately eight different size tibial components with multiple thicknesses of polyethylene to fit between those implants. Further, each of these femoral and tibial components may be further customized by the manufacturing methods described herein to provide even a better fit. Additional, the thicknesses of the polyethylene may be customized based on past analysis of successful operations for similarly situated patients. Where the patella is also resurfaced with polyethylene components of differing diameters and thicknesses, recommendations are made for this procedure as well as the different diameters and thicknesses. Further, computer regression analysis can also make recommendations on patient leg and knee mechanical and anatomical axis alignment and proper patellofemoral tracking. As an example, the computer may compare various pre and post-surgical results for similarly situated patients using a statistical analysis to make recommendations on a distal femoral alignment of approximately five degrees of valgus and proximal tibial alignment of approximately neutral, or zero degrees varus/valgus.

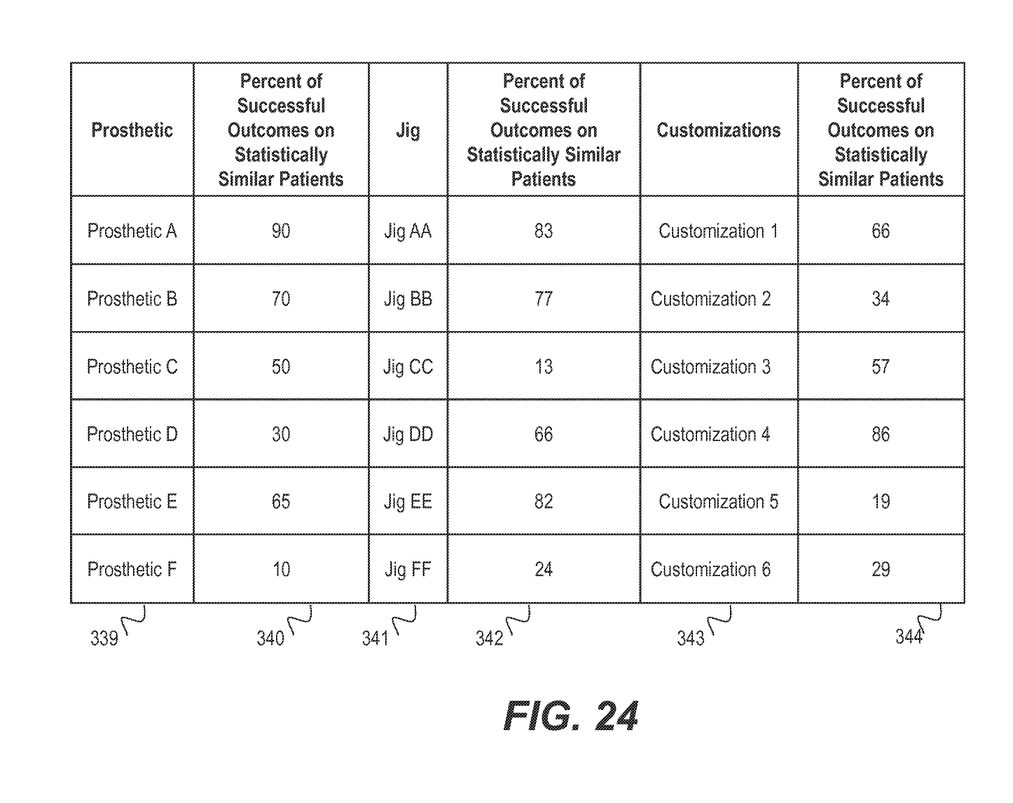

FIG. 24 is an exemplary database screen interface showing another method for sorting the results of the computer analysis and recommendations. This method corresponds to step 363 (see FIG. 19) where the search locates prosthetics, customizations and jigs used on statistically similar patients and then analyses which of these devices and procedures statistically have best and worst outcomes. Column 339 shows all the available prosthetic options which can be made and column 340 shows the percentage of surgeries which used this prosthetic and resulted in a desirable outcome. Column 341 shows all the available jigs and column 342 show the percentage of successful patient outcomes that employ the particular jig for the particular prosthesis. Similarly, for various customizations to the prosthetic and/or jig shown in column 343, column 344 shows the percentage of successful outcomes. In other embodiments, for each prosthetic in column 339 (e.g., prosthetic A), there may be numerous jigs A1, A2, A3, etc., in column 341 and numerous customizations 1(A1)a, 1(A1)b, 1(A2)a, 1A2b, etc. Pictures, images and design specifications for these jigs, prosthetics and customizations may be included in these search results. In one exemplary embodiment, former patients whose parameters are within a variance of 5% of the instant patient are analyzed to determine patients with a good outcome the highest percentage of the time. These patients form the basis for the recommendations shown in FIG. 24.

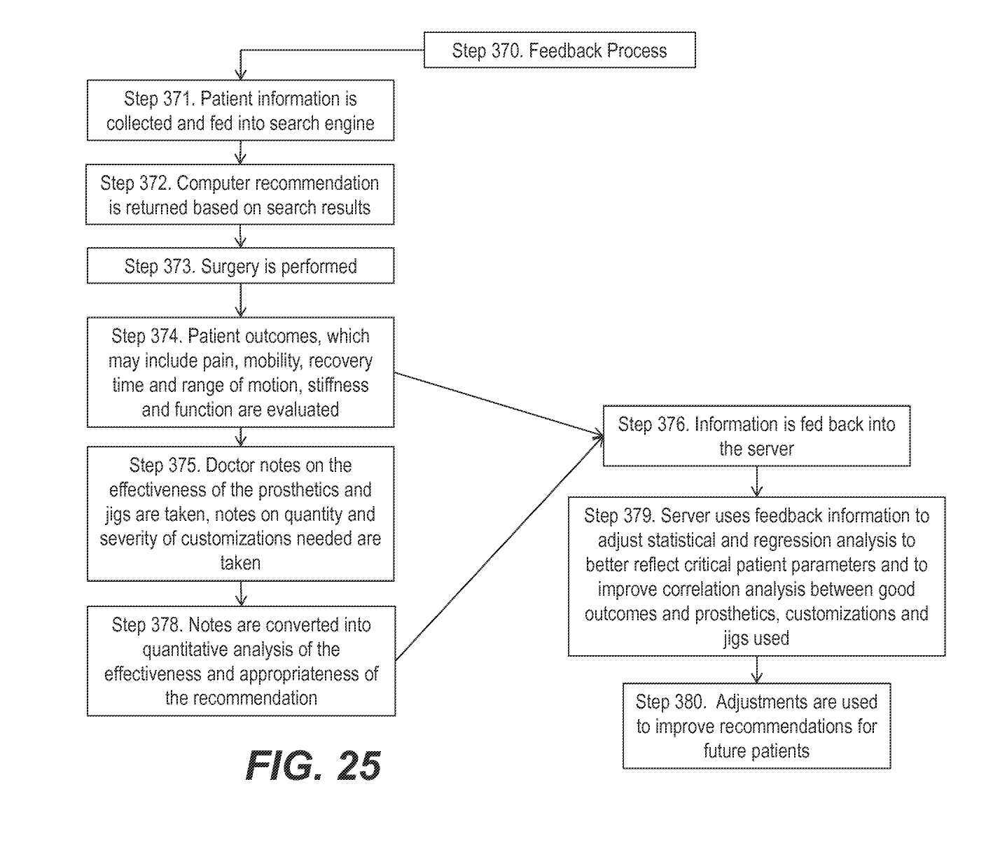

Referring to FIG. 25, an exemplary method for the improvement of the database is provided which improves the artificial intelligence in the recommendation engine by helping to improve the regression analysis and statistical methods described herein using a post-operative feedback process (step 370). Steps 371 and 372 refer to the search process described in more detail in FIG. 19. Once the surgery has been performed using the recommended prosthetics, jigs and customizations (step 373), it may be desirable to create a feedback process in order to improve the computer's analysis of the data in order to create a more effective recommendation process. After the surgery, patient outcomes based on the parameters indicated in step 374 may be evaluated. Furthermore, doctors' notes on the effectiveness the recommended equipment, procedures and prosthetics may be taken and quantified (steps 375 and 376). This information may be fed into the server so that the statistical and regression analysis model may be improved upon (step 379). For example, more weight may be placed on certain parameters which better correlate to success in the operation. These parameters may be varied by the recommendation engine until optimal results are obtained. These improvements may include updates in the correlation analysis between good outcomes and medical equipment, techniques and devices used and updates in which patient parameters prove most crucial in determining which prosthetics, jigs and customizations will be most effective. Based on a current data and analysis of surgical parameters and surgical outcomes, it has been found that the angle of the bony resection made by the custom cutting jig has a strong influence on surgical outcomes. As step 380 indicates, these adjustments in the recommendation and search processes may be used to improve the recommendations for future patients. In still further embodiments, the apparatus may employ a robo-assisted execution of a TKA where the parameters for the cuts to one or more of the various bones are utilized directly by a surgical robot to make the appropriate cuts. Further, the angle and location of the cuts can be made by a robot and/or guided by a laser guiding the surgical operation. Where 3D modeling is utilized in the planning process, various CT slices may be utilized to collect the slices and guide any robotic assisted execution. Further, the robotic assisted surgery may be implemented using a laser or other technique to measure the bone surface, determine appropriate attachment and/or cut locations on the bone to conform to the surgical parameters determined above.

In the specification the expression “approximately” or “generally” is intended to mean at or near and not exactly such that an exact dimension or location is not considered critical in those contexts where those expressions are used.

The expression a scoring register being “greater than or equal to” is intended to indicate a desired result and not necessarily an absolute numerical value. In this while most desirable results are indicated by a high number indicating success it is also possible that the lowest number will indicate success—such as a low pain value—so that greater than or equal to can be a low as opposed to high numeric score value depending upon the circumstance.

The expression scoring register means a numerical value that is used by medically recognized query or testing regimens to record a quality of success value. The expression “successful” or “good” score means a scoring register that is in the best 30% of all scores considered by a surgeon and a medical device manufacturer. The term “highly successful” or “excellent” means scores in the best 15% of all score values considered by a surgeon and/or medical device manufacturer.

As used in this disclosure the expression “outcomes analysis” and “comparative effectiveness” refers to the concept of medically recognized surgical intervention results that are highly desirable or effective on a comparative basis with patient outcomes for similar procedures with less successful actual results.

In describing the invention, reference has been made to preferred embodiments. Those skilled in the art however, and familiar with the disclosure of the subject invention, may recognize additions, deletions, substitutions, modifications and/or other changes which will fall within the scope of the invention as defined in the following claims.

What is claimed is:

1. A method for producing a custom resection jig for a current patient scheduled to receive total knee arthroplasty comprising the steps of:
maintaining a computer searchable database of total knee arthroplasty data including a computer system of (1) prior patient bone morphologies, (2) anatomical bone axis alignment data, and (3) data defining a custom resection jig design with a generally transverse resection window operable to guide a surgeon's generally transverse bone cut for each prior patient that has received a total knee arthroplasty procedure and a post-surgery medically recognized scoring register equal to or better than a predetermined value for a total knee arthroplasty procedure;
using bone imaging data defining a current patient's anatomical leg axis data that is scheduled to receive total knee arthroplasty and matching with a computer current patient anatomical axis data with anatomical leg data from prior patient data within said computer searchable database of patients having post-surgery medically recognized scoring registers equal to or better than a predetermined value; and
creating a custom resection jig for the current patient with a generally transverse resection window operable to guide a physician's resection saw making a generally transverse bone cut using as a guide the patient's total leg anatomical leg data along with custom resection jig data, including generally transverse window geometry of the custom resection jigs, from prior resection jig designs for patients within the computer searchable database of post-surgery patient total knee arthroplasty scores having similar anatomical axis leg data.

2. A method for producing a custom resection jig for a current patient scheduled to receive total knee arthroplasty as defined in claim 1 wherein said step of using bone imaging data comprises:
using magnetic resonance imaging (MRI) data.

3. A method for producing a custom resection jig for a current patient scheduled to receive total knee arthroplasty as defined in claim 1 wherein said step of using bone imaging data comprises:
using cat scan (CT) data.

4. A method for producing a custom resection jig for a current patient scheduled to receive total knee arthroplasty as defined in claim 1 wherein said step of using bone imaging data comprises:
using magnetic resonance imaging (MRI) data and X-ray data.

5. A method for producing a custom resection jig for a current patient scheduled to receive total knee arthroplasty as defined in claim 1 wherein said step of maintaining a computer searchable database with post-surgery medically recognized scoring register values comprises:
maintaining patient data for a scoring register of only successful scoring register values for total knee arthroplasty procedures.

6. A method for producing a custom resection jig for a current patient scheduled to receive total knee arthroplasty as defined in claim 1 wherein said step of maintaining a computer searchable database with post-surgery medically recognized scoring register values comprises:
maintaining patient data for a scoring register of only highly successful scoring register values for total knee arthroplasty procedures.

7. A method for producing a custom resection jig for a current patient scheduled to receive total knee arthroplasty as defined in claim 1 wherein said step of maintaining a computer searchable database with post-surgery medically recognized scoring register values comprises:
maintaining patient data within a computer searchable database including a clinical Knee Society Score (KSS) for patients having a KSS score greater than or equal to 85.

8. A method for producing a custom resection jig for a current patient scheduled to receive total knee arthroplasty as defined in claim 4 wherein said step of maintaining a computer searchable database with post-surgery medically recognized scoring register values comprises:
maintaining patient data within a computer searchable database including a Knee Society Score (KSS) which includes a function score greater than or equal to 85.

9. A method for producing a custom resection jig for a current patient scheduled to receive total knee arthroplasty as defined in claim 1 wherein said step of maintaining a computer searchable database with post-surgery medically recognized scoring register values comprises:
maintaining a computer searchable database including data associated with patient's having a patient completed Hospital for Special Surgery Knee Score (HSSKS) score greater than or equal to 85.

10. A method for producing a custom resection jig for a current patient scheduled to receive total knee arthroplasty as defined in claim 1 wherein said step of maintaining a computer searchable database with post-surgery medically recognized scoring register values comprises:
maintaining a computer searchable database including data associated with patient's having a patient completed Knee Injury and Osteoarthritis Outcome Score (KOOS) score greater than or equal to 85%.

11. A method for producing a custom resection jig for a current patient scheduled to receive total knee arthroplasty as defined in claim 1 wherein said step of maintaining a computer searchable database with post-surgery medically recognized scoring register values comprises:
maintaining a computer searchable database including data associated with patient's having a patient completed Oxford Knee Score having a value greater than or equal to 40.

12. A method for producing a custom resection jig for a current patient scheduled to receive total knee arthroplasty as defined in claim 1 wherein said step of maintaining a computer searchable database with post-surgery medically recognized scoring register values comprises:
maintaining a computer searchable database including data associated with patient's having a patient completed WOMAC Score greater than or equal to 85.

13. A method for producing a custom resection jig for a current patient scheduled to receive total knee arthroplasty comprising the steps of:
maintaining a computer searchable database on a computer system of (1) prior patient bone morphologies, (2) anatomical and mechanical bone alignment data for each prior patient, and (3) data defining a custom resection jig design with a generally transverse resection window operable to guide a surgeon's transverse bone cut for each prior patient that has received total knee arthroplasty and a post-surgery medically recognized scoring register equal to or better than a predetermined highly successful score value for a total knee arthroplasty;
using magnetic resonance image data and leg radiology image data defining a current patient's mechanical and anatomical leg and knee axis that is scheduled to receive total knee arthroplasty and matching current patient magnetic resonance image data and leg radiology data with prior patient data within said database of patients having post-surgery medically recognized scoring registers equal to or better than a predetermined highly successful score value; and
creating a custom resection jig for the current patient operable to intimately conform to the current patient's bone morphology with a generally transverse resection window operable to guide a physician's resection saw making a generally transverse bone cut using as a guide the patient's magnetic resonance image data and total leg radiology data along with jig data including generally transverse window geometry from prior resection jig designs for patients within the database of highly successful post-surgery patient total knee arthroplasty scores having similar magnetic resonance image and radiology data.

14. A method for producing a custom resection jig for a current patient scheduled to receive total knee arthroplasty as defined in claim 13 wherein:
said current bone morphology comprises the distal end of the current patient's femur.

15. A method for producing a custom resection jig for a current patient scheduled to receive total knee arthroplasty as defined in claim 13 wherein:
said current bone morphology comprised the proximal end of the current patient's tibia.

16. A method for producing a custom resection jig for a current patient scheduled to receive total knee arthroplasty as defined in claim 13 wherein said medically recognized scoring register comprises:
a clinical Knee Society Score (KSS) and said predetermined highly successful total Knee Society Score clinician's completed knee score comprises a value greater than or equal to 85.

17. A method for producing a custom resection jig for a current patient scheduled to receive total knee arthroplasty as defined in claim 16 wherein:
said medically recognized Knee Society Score includes a function score and said function score is greater than or equal to 85.

18. A method for producing a custom resection jig for a current patient scheduled to receive total knee arthroplasty as defined in claim 13 wherein said medically recognized scoring register comprises:
a Hospital for Special Surgery Knee Score (HSSKS) greater than or equal to 85.

19. A method for producing a custom resection jig for a current patient scheduled to receive total knee arthroplasty as defined in claim 13 wherein said medically recognized scoring register comprises:
a patient completed Knee Injury and Osteoarthritis Outcome Score (KOOS) and the highly successful KOOS knee score comprises a value greater than or equal to 85%.

20. A method for producing a custom resection jig for a current patient scheduled to receive total knee arthroplasty as defined in claim 13 wherein said medically recognized scoring register comprises:
a patient completed Oxford Knee Score and the highly successful Oxford Knee Score comprises a value greater than or equal to 40.

21. A method for producing a custom resection jig for a current patient scheduled to receive total knee arthroplasty as defined in claim 13 wherein said medically recognized scoring register comprises:
a patient completed WOMAC Score and the highly successful WOMAC Score comprises a value greater than or equal to 85.

22. A method for producing a custom resection jig for a current patient scheduled to receive total knee arthroplasty as defined in claim 13 wherein:
said custom generally transverse resection jig is designed with an interior surface that will intimately fit the exterior surface of the distal end of the current patient's femur; and
said custom generally transverse resection jig in addition to having a generally transverse resection window includes at least two aperture columns fashioned through the jig and extending generally perpendicular to an imaginary plane of the custom jig resection window, said apertures being operable to guide evacuation of longitudinally extending recesses in the distal end of a patients femur bone and said longitudinally extending recesses being operable to receive alignment pins of a four-in-one femur resection jig.

23. A method for producing a custom resection jig for a current patient scheduled to receive total knee arthroplasty as defined in claim 22 wherein said four cut femur resection jig comprising:
registry pins operable to be intimately received within said longitudinal extending columns of a current patient's femur and said four cut femur resection jig having resection windows operable to guide a surgeon in making (1) an anterior femur cut, (2) an anterior chamfer cut, (3) a posterior chamfer cut and (4) a posterior femur cut.

24. A method for producing a custom resection jig for a current patient scheduled to receive total knee arthroplasty as defined in claim 14 wherein:
said generally transverse resection window of said custom fitting jig for a current patient's femur being angled with respect to a patient's mechanical axis in front view to produce an anatomical angle of a patient's femur five degrees valgus.

25. A method for producing a custom resection jig for a current patient scheduled to receive total knee arthroplasty as defined in claim 15 wherein:
said generally transverse resection window of said custom fitting jig for a current patient's tibia being angled with respect to a patient's mechanical axis in front view to produce an anatomical angle of a patient's tibia of zero degrees varus.

26. An apparatus comprising:
one or more processors including:
a database configured to correlate physical parameters associated with a total knee arthroplasty of a patient, configurations associated with a prosthesis, and operative success,
an input for inputting parameters associated with a current patient; and
an output for outputting a recommendation of configurations associated with a prosthesis based on at least operative success.
